(19) United States
(12) Patent Application Publication
(10) Pub. No.: US 2012/0244501 A1
(43) Pub. Date: Sep. 27, 2012

(54) HEALTH RECORD

(76) Inventor: Russell Shaw, Tarragindi (AU)

(21) Appl. No.: 13/513,935

(22) PCT Filed: Dec. 7, 2010
(86) PCT No.: PCT/AU2010/001651

§ 371 Date: Jun. 5, 2012

(30) Foreign Application Priority Data
Dec. 11, 2009 (AU) 2009906051

(51) Int. Cl. G09B 19/00

(52) U.S. Cl. 434/127

(57) ABSTRACT

The invention relates to a record sheet for monitoring and evaluating behaviour modifications, particularly in relation to health, and method of monitoring and evaluating behaviour modifications.

### FIELD OF THE INVENTION

The invention relates to a record sheet for monitoring and evaluating behaviour modifications, particularly in relation to health.

### BACKGROUND OF THE INVENTION

Generally good health is recognised as being related to setting good behavioural habits such as eating healthy, wholesome food regularly as opposed to consuming junk or take away food, exercising and undertaking recreational activities, and leading a balanced lifestyle.

In this age of take away meals, fast life styles and lack of attention to personal health, it is imperative that individuals take control of their lives to lead a more healthy and productive life. The task of maintaining a healthy life style is not easily achieved unless individuals seriously adhere to a program outlining a series of goals focusing on improving and changing behaviour.

While there exists a number of organisations and clubs that provide support and instructions on ways to improve health, there remains a need for a program that meets the goals of individuals at a personal level

It is an object of the invention to improve the health of individuals.

### SUMMARY OF THE INVENTION

The present invention provides a method for evaluating the effectiveness of a health program comprising:

(i) selecting type of activity;

(ii) recording activity periodically;

(iii) assessing progress of program;

(iv) analyzing progress based on results of progress; and

(v) evaluating results, wherein the progress of a subject is monitored by recording daily activities on a score card, entering a score for each activity, and representing the score in graphic form.

Preferably, the score for each activity is based on a set of daily challenges.

Preferably, the daily challenges are selected from the group consisting of the following: (i) to undertake >30 minute exercise; (ii) to complete flexibility exercises; (iii) to eat a healthy breakfast; (iv) to eat a wholesome lunch; (v) to eat a balanced dinner; (vi) to eat only healthy (or no) snacks; (vii) to consume no alcohol or drugs; (viii) to not smoke; (ix) to spend >30 minutes with my family; and (x) to spend >30 minutes for/on myself.

Preferably, the score records an uncompleted activity.

Preferably, the score records a completed activity.

Preferably, the score is recorded over 7 days each week over a series of weeks.

Preferably, the score is recorded as an average for each week.

Preferably, the score recorded over a series of weeks is represented in graphic form.

Preferably, the score is recorded over a series of 13 week segments.

In another aspect, the invention provides a kit comprising a personal health and lifestyle record based on the method of the invention and a graphic representation according to the method of the invention.

In another aspect, the invention provides a computer program comprising storing and retrieving data based on a health program record comprising:

(i) selecting type of activity;

(ii) recording activity periodically;

(iii) assessing progress of program;

(iv) analyzing progress based on results of progress; and

(v) evaluating results, wherein the progress of a subject is monitored by recording daily activities on a score card, entering a score for each activity, and representing the score in graphic form.

In another aspect, the invention provides a method of monitoring a health program comprising:

(i) selecting type of activity;

(ii) recording activity periodically;

(iii) assessing progress of program;

(iv) analyzing progress based on results of progress; and

(v) evaluating results, wherein the progress of a subject is monitored by recording daily activities on a score card, entering a score for each activity, and representing the score in graphic form.

### BRIEF DESCRIPTION OF THE DRAWINGS

FIG. 1 illustrates a “Personal Health and Lifestyle Record” card based on daily challenges.

FIG. 2 illustrates a “Personal Health and Lifestyle Record” card based on the average score over a period of 13 weeks.

### DETAILED DESCRIPTION OF THE INVENTION

The present invention provides a method for monitoring and evaluating the effectiveness of a health program.

The health record of the present invention may provide a motivational, educational and documentation aide to health modification in a convenient, reliable and manageable format such as a hand held size sheet or card, and other forms of delivery such as via a mobile phone application, purpose built electronic format (such as a modified calculator) and the like. The record sheet may be used in conjunction with a program or may be used on its own with references given to comprehensive and/or specific ideas. The record sheet is not intended to necessarily substitute for a comprehensive program, but may be used as a complementary aid. The record sheet or card may be adaptable to meet individual goals or relate to a specific medical condition, such as, for example, diabetes, obesity, hypertension, high blood pressure, heart disease, arthritis, or the like. The record sheet may also be adaptable for measuring several indicators of health progress, such as, for example, weight, calorie intake, amount and type of exercise, cholesterol level, amount of fat, sodium and sugar, amount of alcohol consumed, number of cigarettes smoked, recreational periods, illicit drug use, blood pressure measurements, or the like.

Setting of Target Score

A motivational component of the cards is the setting of a target score so the user has a predetermined goal in mind at the start of the day/week/program period. This target score may be revised periodically, preferably weekly.

Recording Periods

The measurements of health progress may be recorded daily, weekly, or monthly. In a preferred embodiment, a weekly and/or monthly average is used for a reliable and objective indication of changes and/or trends. The measurements may be recorded once per day and may be used to compute average weekly figures. Furthermore, preferably, the average weekly figures may be computed over a period of 13 week segment. Alternatively, measurements may be recorded once a week and used to compute average monthly figures. Moreover, the measurements may be in the form of averages, minimum/maximum data, summary data, delta measurements and the like wherein the weekly and monthly figures create a visual aid to identify weekly and monthly progress and/or trends. While the invention has been and will be described with respect to weeks, months and/or years, it should be understood that the calendar of the present invention may be adapted for any predetermined and/or periodic length of time.

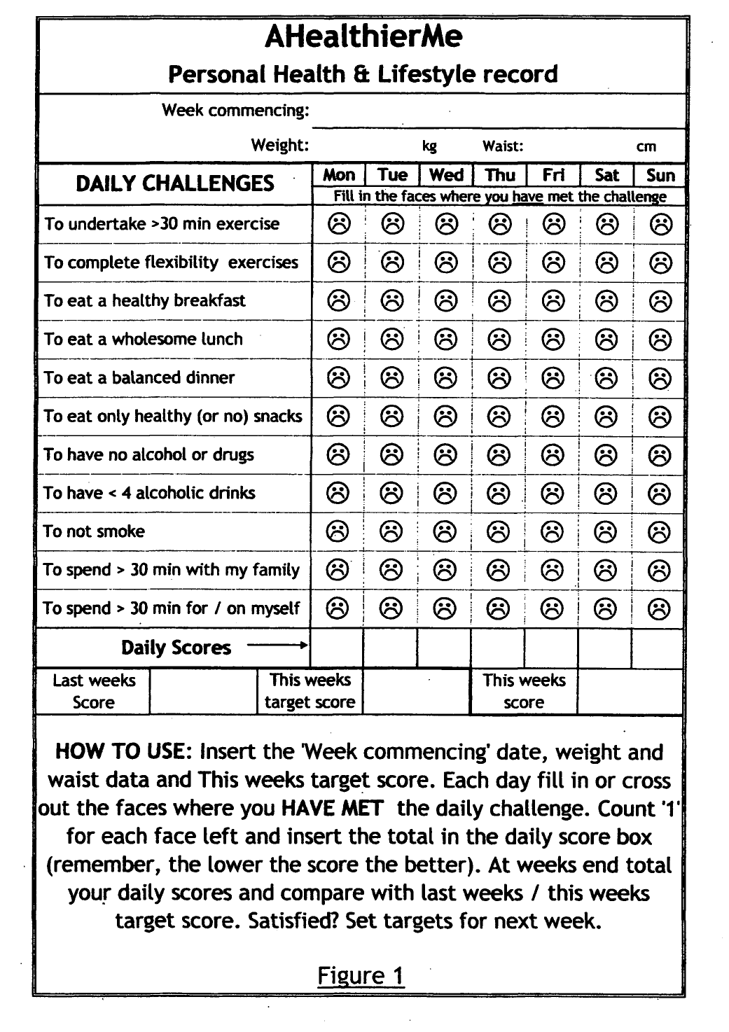

FIG. 1 illustrates a “Personal Health & Lifestyle” record card 1 based on daily challenges.

The record card includes information relating to personal details such as weight, waist and height of the person participating in the program. The column under “Daily Challenges” lists the different activities which the participant has elected to achieve. These challenges may be modified to include other personalized activities, or to remove activities. Each activity is then recorded as being achieved or met or not met over a seven day cycle. The face on the sheet is filled in or crossed out for each completed activity each day. Each remaining face on the sheet counts as 1 and indicates the challenge which was not achieved on that particular day. At the end of each week, the total of the daily score for each day provides the target score for that week. The lower the score, the better the performance of the participant. The participant may elect a personal target score for each week.

The target score for the week is indicated on the card and compared with the score for that week to determine the progress of the health performance of the participant based on the selected challenges. As an incentive to improve health, the target score may be varied each week progressively over a series of weeks to set better challenges in an effort to achieve better results.

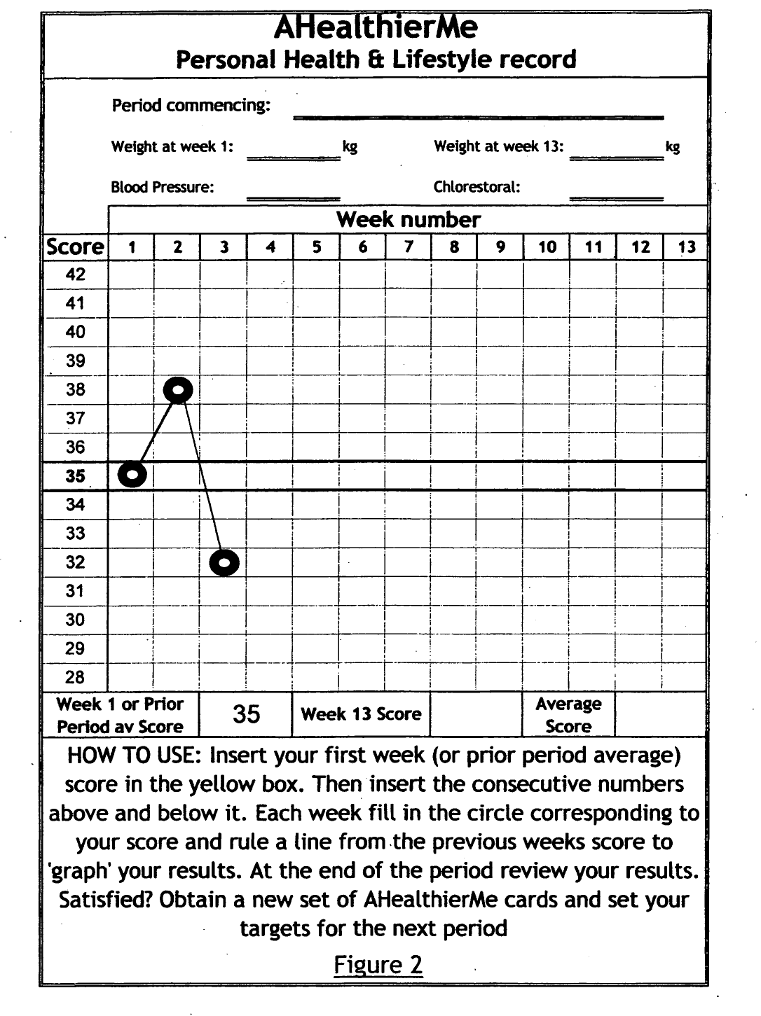

FIG. 2 illustrates a “Personal Health & Lifestyle” record card 2 based on the average score over a period of 13 weeks.

The record card includes information relating to personal details such as weight at different periods of the program, preferably at weeks 1 and 13, waist and height of the person participating in the program. Medical information such as level or reading of blood pressure measurements and level of cholesterol may also be recorded on this card to monitor progress of the participant over a period. The average score for each week obtained from Card 1 over a period of weeks, preferably, 13 weeks, is recorded in the middle of the card corresponding to a coloured line, preferably yellow to highlight the score for each week. The score is also recorded each week on a predetermined scale above or below this line, depending on the value of the score. A line is drawn to join the score for each subsequent week to generate a graph indicating the performance of the participant over a period of time, preferably 13 weeks.

Analysis of the score for the week assists in determining whether the challenges were too simple (eg very low score) or too difficult (eg, high score) for the participant. The results for each week are monitored and evaluated to set target scores for subsequent weeks.

In another aspect, the scores may be entered into a computer program to facilitate data entry and processing according to the present invention. The program would enable storing and retrieval of data according to the record cards of the present invention. The program would be designed to be capable of generating graphs to monitor and evaluate the performance of an individual participating in the health program.

While considerable emphasis has been placed herein on the specific features of the preferred embodiment, it will be appreciated that many additional features can be added and that many changes can be made in the preferred embodiment without departing from the principles of the invention. These and other changes in the preferred embodiment of the invention will be apparent to those skilled in the art from the disclosure herein, whereby it is to be distinctly understood that the foregoing descriptive matter is to be interpreted merely as illustrative of the invention and not as a limitation.

1-15. (canceled)

16. A method for evaluating the effectiveness of a health program comprising:
(i) selecting a type of activity;
(ii) recording the activity periodically;
(iii) assessing progress of the program;
(iv) analyzing progress based on results of progress; and
(v) evaluating results, wherein the progress of a subject is monitored by recording daily activities on a score card, entering a score for each activity, and representing the score in graphic form, the score for each activity is based on a set of daily challenges consisting of the following: (i) to undertake >30 minute exercise; (ii) to complete flexibility exercises; (iii) to eat a healthy breakfast; (iv) to eat a wholesome lunch; (v) to eat a balanced dinner; (vi) to eat only healthy (or no) snacks; (vii) to consume no alcohol or drugs; (viii) to not smoke; (ix) to spend >30 minutes with my family; and (x) to spend >30 minutes for/on myself wherein the score records a point for an uncompleted activity.

17. The method according to claim 16, wherein the score is recorded over 7 days each week over a series of weeks.

18. The method according to claim 17, wherein the score is recorded as an average for each week.

19. The method according to claim 18, wherein the score recorded over a series of weeks is represented in graphic form.

20. The method according to claim 19 wherein the score is recorded over a series of 13 week segments.

21. A method for evaluating the effectiveness of a health program undertaken by a subject comprising:
(a) recording one (1) point daily for each activity not completed by a subject from a daily set of activities:
(b) totaling the points recorded in step (a) on a daily basis, wherein the set of daily activities consist of at least the following activities:
(i) undertaking >30 minute exercise;
(ii) completing flexibility exercises;
(iii) eating a healthy breakfast
(iv) eating a wholesome lunch;
(v) eating a balanced dinner;
(vi) eating only healthy (or no) snacks;
(vii) consuming no alcohol or drugs;
(viii) not smoking;
(ix) spending >30 minutes with the subject's family; and
(x) spending >30 minutes for/on the subject's behalf.

22. The method according to claim 21, wherein the score is recorded over 7 days each week over a series of weeks.

23. The method according to claim 22, wherein the score is recorded as an average for each week.

24. The method according to claim 23, wherein the score recorded over a series of weeks is represented in graphic form.

25. The method according to claim 24, wherein the score is recorded over a series of 13 week segments.

26. A computer program comprising storing and retrieving activities recorded by the method according to claim 16.

27. A computer program comprising storing and retrieving the points recorded by the method according to claim 21.

28. A kit comprising a personal health and lifestyle record comprising comprising at least one score card listing a set of daily challenges consisting of the following: (i) to undertake >30 minute exercise; (ii) to complete flexibility exercises; (iii) to eat a healthy breakfast; (iv) to eat a wholesome lunch; (v) to eat a balanced dinner; (vi) to eat only healthy (or no) snacks; (vii) to consume no alcohol or drugs; (viii) to not smoke; (ix) to spend >30 minutes with my family; and (x) to spend >30 minutes for/on myself, wherein the scorecard can be marked to record each daily challenge which is not achieved on a particular day.

29. A kit according to claim 28, wherein the scorecard can be marked to record the total number of daily challenges that are not achieved on both a daily and weekly basis.

30. A kit according to claim 29, further comprising at least one graphic form for graphing the total number of daily challenges which are not achieved on a weekly basis over a number of weeks.

31. A kit according to claim 29, where the scorecard and graphic form are hand held sheets or cards.

32. A kit according to claim 29, where the scorecard and graphic form are electronic media.
